(19) United States
(12) Patent Application Publication
(10) Pub. No.: US 2007/0029386 A1
(43) Pub. Date: Feb. 8, 2007

(54) Method for coding RFID tags in printer label applications

(75) Inventor: Steven Jessup, Meridian, ID (US)

Correspondence Address: DEREK H. MAUGHAN;DYKAS, SHAVER & NIPPER, LLP, PO BOX 877, BOISE, ID, 83701-0877, US

(73) Assignee: Ensyc Technologies, Reno, NV (US)

(21) Appl. No.: 11/200,410

(22) Filed: Aug. 8, 2005

(51) Int. Cl. G06K 7/00; G06F 17/00

(52) U.S. Cl. 235/440; 235/375

(57) ABSTRACT

A method for reading and encoding RFID tags in a label printer configuration. A low cost close range RFID Reader which is operatively connected to a control device which contains a transmitter and is configured to function as a homodyne receiver. The device can be constructed from low cost parts and can function in close ranges to other tags. The method of the present invention provides the activation of reading and writing hardware to read and write information upon a tag and a label.

### BACKGROUND OF THE INVENTION

1. Field of the Invention

The present invention generally relates to identification systems and more particularly to a method for preparing and coding RFID tags at close range, such as in a printer label application.

2. Background Information

Radio Frequency Identification Systems (RFIDs) are used in a variety of industries to identify, track, and provide various other types of information related to the items upon which the tag is placed. These devices are useful in identifying and determining the various features of the products upon which these labels are placed. In order to coordinate and streamline the functionality of these labels as well as the readers which are used in conjunction with these tags, a variety of generally accepted standards and protocols have been accepted and are generally used.

A typical RFID system is usually made up of at least one transmitting and receiving device commonly called a reader and at least one passive or active target device, typically called a tag. The basic principal of this system involves the transmission of radio frequency energy from the reader to the tag. The tag then modifies that energy and reflects this modified signal back to the reader, where the reflected and modified return signal is read and decoded. In many instances, the reader is the initial transmitter of both the power for the passive tag as well as the information carrying signal.

A variety of types of tags exist. Most tags contain a receiver and a modulating device for transmitting a modulated signal back to the reader. The reader contains an antennae means for receiving information from the tag and reading this information. The transmission of information and power between the reader and the tag is typically accomplished by the modulation of the RF carrier. In many instances the tag is what is called a passive tag and receives power to modulate the signal only through the receipt of transmission material from the reader. In these instances the reader is maintained in the ON state to provide power to the passive tags and is pulsed off and on for short intervals following the prescribed modulation timing and amplitude variations of the specific tag classification.

Some passive tags incorporate a capacitive storage mechanism to provide the required power for these pulse intervals. In the reverse direction, (the transmission from the tag back to the Reader is also referred to as the reverse link) information is oftentimes transferred using a backscatter technique. In this backscatter technique, radio frequency (RF) energy incident on the tag antennae is modulated by changing the impedance of the antennae and effectively changing the radar cross section (RCS) of the tag and the amplitude of the energy reflected back to the reader.

In other instances the tag impedance is such that the tag absorbs the RF energy, which is then used to power the tag. The tag changes the antenna impedance following the timing requirements of the specific tag classification effectively increasing the reflectivity of the tag and amplitude of the backscattered carrier received at the reader. In these systems, the reader provides power to passive tags by maintaining a constant RF carrier throughout the entire transaction with the tag. In some circumstances, this constant sending of a signal combined with the backscattered response signals can be problematic particularly in applications where the reader is in close association with a plurality of tags or when the reader and the tags are in close contact with one another. This close association of the tags can cause the compression of signals as well as the compression of the modulated signals emanating from these tags. This results in signals which are difficult to separate or individually ascertain.

Various attempts have been made to address this problem of mixing signals and overscatter, particularly when these tags are in close proximity to one another.

This weakness in the present system has made the simultaneous printing and programming of RFID labels from a single location or device very difficult. Where such systems have been implemented, the equipment utilized to achieve these results has been too expensive to allow for widespread use of this technology or the use of this technology in conjunction with the many items in common commerce.

The inventor of the present method has invented a low cost RFID system which allows tags to be utilized in conjunction with a label printer, where a reader can be used in close proximity with a plurality of tags in such a way whereby individual tags can be isolated, selected, programmed and verified. This system is made of inexpensive parts which allow the device to be manufactured cheaply and used in a broad range of applications. This low cost RFID system should be able to function in close environments even in the presence of other tags and be able to function in an environment where a tag is included on a label which is printed in a printer and encoded. The present invention provides these advantages and does so in a way that is sufficiently reliable and cost effective so as to be accessible and useful in a variety of varying embodiments.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a method for printing, coding and verifying RFID tags in a printer label application. The method of the present invention is intended for use with an identification system that performs and allows interactions between a reader and an individual tag at close range in environments where multiple tags exist, such as in a label printer environment. In the preferred embodiment of the invention, the method can be performed utilizing a reader that can both read and write EPC class 1 and Gen2 tags and includes the features necessary to identify the tag, verify proper operation, and optionally write specific data to the tag under the direction of a host controller.

The tags which are utilized with the present invention are embedded into readable labeling materials which can be read in either electronic or human readable form. These Radio Frequency Identification (RFID) tags incorporate an Electronic Product Code (EPC) used for item identification in accordance with evolving standards. There are three standards that have been widely accepted for this identification. EPC Class 0, Class 1 and Gen2. Each of these standards involves an air interface standard, Electronic Product Code and a set of commands for reading and optionally writing the tag. In the preferred embodiment of the invention the labels are marked with information such as a bar code label or a human readable label. However, the electronically readable tag provides a medium for increasing the quantity of material and information which is capable of being stored upon a tag. In addition, in the event that these items are damaged the electronically readable tag can then be read and optionally programmed with additional information for tracking and identification purposes.

The method of the present invention is utilized in a configuration where a reader provides power to the passive tags by maintaining an RF carrier throughout the entire transaction with the tags. In the preferred system the method of the present invention is utilized in an embodiment where a tag and a reader are used in combination with a printer for labels so as to provide a single device that provides both electronically and human readable information.

The printer of the present invention is operatively connected to a control mechanism which dictates the type and form of information which can be printed upon the label. When commanded by the control device, the label in the printer is printed and forwarded out of the device to another location. When this label passes out of the printer this label then passes past a sensor on the reader device.

When the label passes under the sensor on the RFID reader the RFID mechanism is activated and the reader makes multiple read attempts to attempt to determine the identity of the RFID tag within the label. If the label is successfully read, then the scanner is activated and the bar code on the label is read. If the tag and the bar code and the tag are both successfully read, the data handler signals the RFID reader to write information to the tag. This information is then verified. If the tag passes through all of these steps successfully, then the tag may be utilized and placed upon a particular item. If the tag fails to pass any of these steps after various attempts to troubleshoot and rectify the problem the tag is not written and is not suitable for use. This invention provides a significant advantage over the prior art in that this device allows for the quantity and quality of information which is placed upon a tag to be significantly increased and significant amounts of information regarding an item to be placed upon a tag and for this tag to be created in a single location.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 shows the general conceptualized hardware configuration in which the present method is performed.

FIG. 2 is a flow chart of the method of the present invention.

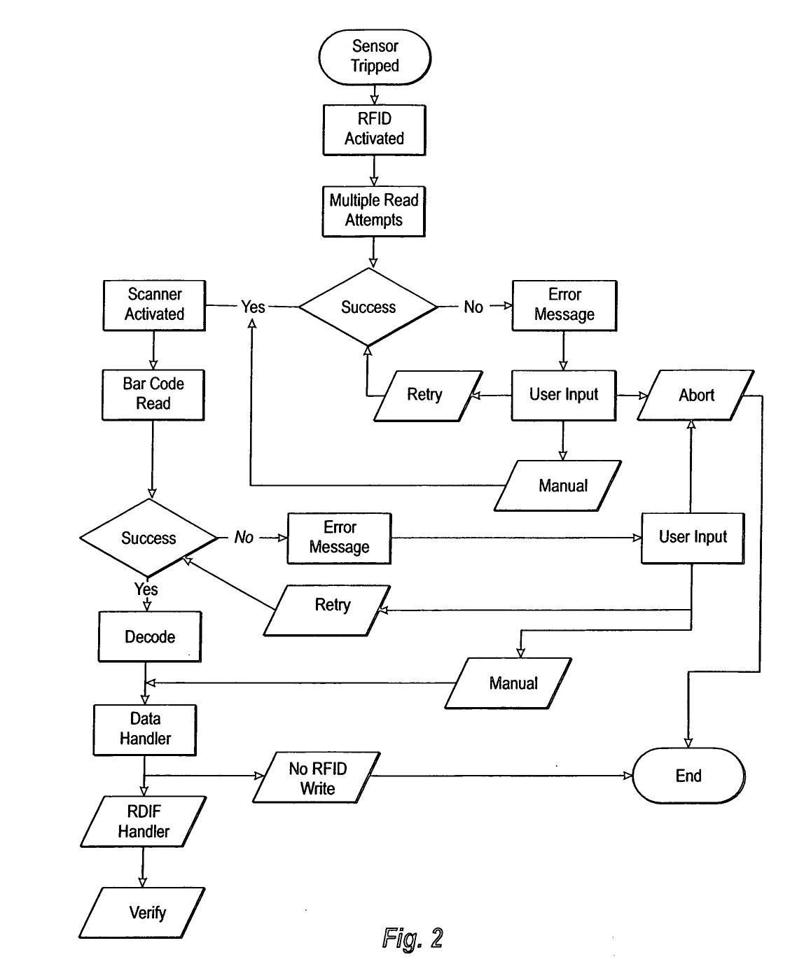

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

While the method of the present invention is described as functioning within the Applicant's particular system described below as well as in a concurrently filed pending United States Patent Application entitled LOW COST CLOSE RANGE RFID SYSTEM FOR PRINTER LABEL APPLICATIONS and filed by the same inventor, it is to be distinctly understood that the invention is not limited to use within this particular system but may also be utilized in a variety of other physical configurations as well.

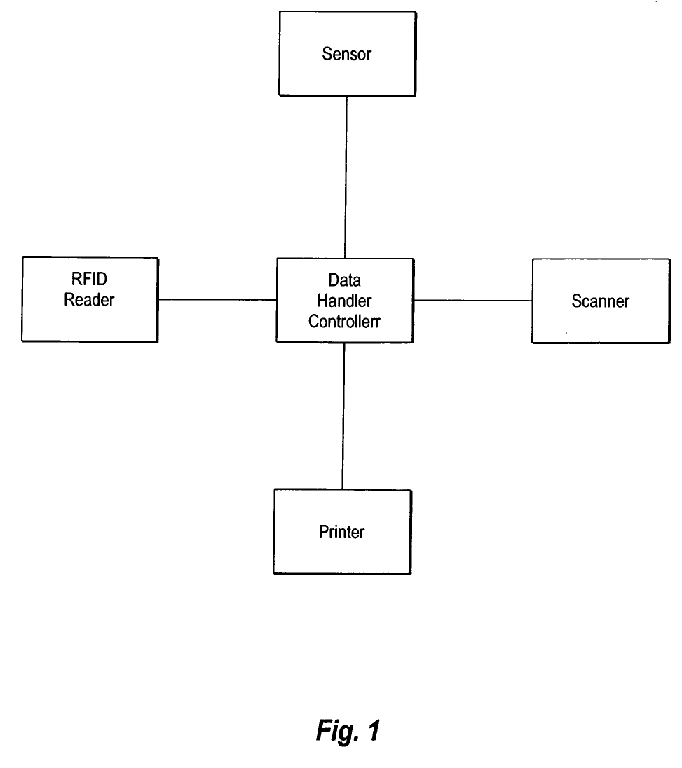

FIG. 1 shows the combination of hardware features of the present invention and the hardware configuration in which the present invention interacts with and with which they are utilized. Preferably, the present invention is utilized within a combination device which includes a system for RFID communications, a label printer configured to print a specified labeling indica, preferably a bar code upon a label, a scanner configured to read the specified labeling indicia, and a host controller having a data handler and an information processing device which enables the exchange of information between the various other pieces of the present invention. In this preferred embodiment, an RFID reader device is operatively coupled to a host controller and positioned near a label printer so as to allow the labels that are exiting the label printer to pass under a scanner, which is operatively connected to the reader itself. While a sensor is also shown as being operatively connected to the host controller, in the preferred embodiment of the invention this sensor is physically integrally connected to the reader.

In the preferred embodiment of the invention, the various pieces of hardware in which the method operates, namely the Reader having the previously described characteristics, the printer and the associated labels and the control computer are positioned so that labels fed from a storage location within the label printer pass a printing mechanism such as a print head of the label printing device. In the preferred embodiment of the invention, these labels are placed upon continuous rolls of material which are configured to unwind and display these labels in a continuous row. After these labels have been printed, preferably including a visual coding mechanism such as a bar code label, these labels are moved forward as the subsequent labels are printed. The printing of these later labels pushes the earlier printed labels forward out of the printer. A sensor is placed near the printer in a position whereby these labels after being printed are enabled to move past this sensor and toward the Reader. Along with the sensor and the Reader a scanner such as a bar code scanner is also included. This bar code scanner is also connected with the host or control mechanism, which acts to coordinate the inputs from the scanner and the RFID Reader as well as to operate the following inventive method.

In the preferred embodiment of the invention the method commences when the label containing the RFID tag passes the sensor. When this takes place, the sensor recognizes the presence of the printed label and activates the RFID reader device to make contact with or “read” the RFID tag, which is imbedded within the label. The RFID Reader then makes several attempts to contact. If this “read” attempt is successful, a bar code scanner is activated and the bar code which has been printed upon the label is read. If this bar code read is successful, then the information from this code is decoded and sent to a data handler or control device. This control device then transmits this information to the RFID reader which writes this information on the RFID tag. This written tag is then verified to ensure that the information was appropriately recorded upon the tag and that the tag is functional. If all of these steps take place, then the tag and the label are appropriate for function and can be used.

If however at the initial RFID reading stage, the read is unsuccessful despite multiple read attempts, an error message is displayed and the operator is provided with the option of aborting the attempts, retrying the read or manually activating the scanner. In the event that these subsequent attempts are unsuccessful, these same options are continually made available to the user.

If, after the scanner is activated and an attempt has been made to read the bar code label, but this bar code read has been unsuccessful, an error message is sent to the user. After this error message has been received, the user is provided with the opportunity to manually input the information from the bar code reader into the data handler, to have the scanner retry reading the bar code, or to have the process aborted. If the operator selects to retry to read the system but is continuously unsuccessful, these options will be continuously represented to the user.

Once the information from the bar code has been placed into the data handler, either manually or by the bar code reader, the RFID reader then attempts to write this information to the RFID tag. If the RFID device is capable of writing information on to the tag but is unsuccessful in writing to a particular tag, the process ends. If however, the information from the tag is successfully written to the tag, this information is verified. If the verification process verifies that the tag reads back the information which was originally written upon it, the process is complete.

The present invention thus provides a device and a method for printing and programming RFID tags in conjunction with a label printer. The present invention utilizes simple parts which can be cost-effectively combined and utilized to achieve these ends and provides an easily installable method and device for performing these functions.

In the preferred embodiment of the invention, the reader is a homodyne receiver and transmitter device made up of a single channel RF oscillator. Preferably, this reader is comprised of a single RF oscillator which is operatively connected to a power-splitter. This power-splitter propagates output from the RF oscillator to both the antenna system as well as to a mixer. This configuration provides a significant advantage over the prior art in that this device allows for the carrier and the local oscillator to each operate at the same frequency. In most prior art devices homodyne receivers require the presence of a double balanced mixer and quadrature components of a local oscillator to minimize the nulls encountered in a multi-path environment. However in the present invention, the application is intended for the reader to function at a distance of between three and six inches from the tag. This distance allows for a device operating a 900 Mhz to function at the points of the half wavelength and the transmitter and receiver can be tuned so as to allow the nulls to be positioned at the extremities of the path tolerance. This removes the additional cost which is found in many of the prior art devices, while still maintaining a device that functions properly in the intended environment.

The particular band width in which the device operates can be varied so as to comply with the specific necessities of the user. In embodiments within the United States the reader contains a transmitter which is adjustable over a frequency range of 804 megahertz to 940 megahertz employing FHSS using 50 hop channels according to the FCC requirements. Additionally, the output power is preferably adjustable from 70 dBm to 30 dBm. The particular ISM band, and power output listed above is merely illustrative in nature and is not limiting in any way. Depending upon the specific regulatory mechanisms involved in various particular countries the exact specifications of the individual devices and their relative operating parameters may be altered according to the particular location in which the device is utilized.

The readers of the present invention preferably contain a controller which is directly operatively connected to an RF transmitter, an amplifier, an acquisition switch and a transceiver. These basic pieces provide a low cost reader configuration which allows these devices to be utilized in closely spaced applications, such as in conjunction with a label printer. The homodyne receiver mixes the RF signal directly to the baseband by operating the (LO) local oscillator at the transmit frequency. This synchronization, and carrier rejection is accomplished by using a DC acquisition filter under the control of a high-speed microcontroller. By synchronizing the acquisition filter with the transmit modulation the DC level can be subtracted from the signal prior to the base band amplifier, effectively providing a fast acquisition band pass-filter at the signal modulation frequency. Preferably, this local oscillator has sufficiently low phase noise so as to provide an adequate noise floor to reliably demodulate backscatter signal.

The controller contains an integral voltage current oscillator (VCO) which is controlled by the controller and minimizes low phase noise. An RF amplifier provides power into the antenna system. A microstrip directional coupler provides signal isolation and minimizes transmit insertion loss. A mixer converts the RF signal directly to baseband in a simple homodyne configuration. This configuration allows for signals to be sent and received by this reader in a way that is functionally proficient and which also can be done with components that are of sufficiently low cost so as to lower the costs of the RF readers and allow RF tags to be used in a variety of industries and with a variety of products which were previously unobtainable due to these cost restraints.

The Frequency Hopping Spread Spectrum (FHSS) technique spreads the RF energy over a large spectrum thus minimizing interference between the signals of various tags. This technique also results in a much more uniform response emanating from a tag compared to using a single frequency and avoids the nulls and peaks that are found in many non-anechoic spaces. In a typical embodiment of this method, fifty independent channels are assigned and scanned in a pseudo-random sequence allocating one individual channel for approximately 0.4 seconds during a 20 second period. This allows the communication between the reader and the tag to occur at a significantly faster pace than the prior art methods and allows multiple Reader/Tag operations to occur in a single hop. This process significantly reduces and in many instances eliminates the interruption of reader-tag operations that occur from a loss of synchronization that may result in the middle of a reader-tag exchange.

The output mixer of the reader is filtered and buffered to provide a baseband signal with a low impedance drive. The baseband amplifier will provide a gain to be sampled by the integral A/D converter and subsequently processed by the microcontroller. This microcontroller also provides a variety of other functions such as acting as a slicer to filter, edge detect and decode messages received from the tags. The receiver mixes the RF signal directly to the baseband by operating the local oscillator at the transmit frequency. Using a DC acquisition filter under the control of a high-speed microcontroller prevents high-speed rejection. By synchronizing the acquisition filter with the transmit modulation, the DC level associated with the carrier can be subtracted from the signal prior to the base band amplifier, effectively providing a fast acquisition band-pass filter at the signal modulation frequency.

The antenna of the present invention preferably contains a tightly contained pattern to avoid activating additional tags in the printer. The antennae incorporates a mechanism to provide a minimum of 25 db carrier isolation. Dipoles can provide isolation, however they can also be detuned by the tag proximity. A modified transmission line using a section of microstrip with a thick dielectric and ground only under the trace terminated by 50 ohms has low sensitivity but is not easily detuned by the Tag. Circular polarization is important when the Tag orientation is unknown. For the printed application, linear polarization may be used if Tag orientation can be fixed. Cross polarization can also be used involving the use of crossed dipoles or a patch antennae.

The receiver includes a local oscillator with significantly low phase noise so as to provide an adequate noise floor to reliably demodulate backscatter signal. The transmit carrier at the receiver utilizes frequency hopping spread spectrum (FHSS) to spread the RF energy over a larger spectrum, minimizing interference. This technique results in a much more uniform response from a tag compared to using a single frequency and avoids the nulls and peaks which are found in any non-anechoic space. The advantages of frequency hopping, coupled with regulatory requirements have made FHSS a common component of most reliable RFID operations.

The receiver components of the present system reduce the transmit carrier at the receiver by 24-30 Db, provide a baseband band width of at least 3.3 Mhz, allows for RF DC recovery. This allows for the device to meet Federal Communication Commission requirements, and to function with EPC Class 0 tags. The present invention utilizes a passive mixer to avoid saturation from RF or IF Direct Current (DC). The baseband amplifier recovery must follow the RF DC recovery. DC acquisition is incorporated into the device to avoid DC errors at the bit slicer. The use of a single mixer as described above saves costs. In addition the Carrier and LO phase can also be adjusted to provide to maximum signal according to the path length. Reducing the LO phase noise to the minimum reduces the noise floor and improves the reliability of reception. A floor of −75 dBc/Hz is preferred.

In the preferred embodiment of the invention the labels which are processed through the printer contains a plurality of the RFID tags. These labels are configured to have a first side configured to be printed upon and a second side which contains an adhesive which would allow these labels to be affixed to an item after this label is printed.

The RFID tags which are utilized in these labels can be broke down into any of the various classifications of tags, namely EPC 0, EPC1 and GEN2 types of tags. The invention of this device is not however limited to use in conjunction with these tags and the use of other types of tags is also possible with the making of appropriate modifications to the Reader. A typical tag contains bits of data which define various information about the tag and its contents. The type and configuration of these types of tags vary upon the type of tag that is being used. For purposes of illustration alone the following information regarding EPC class 1 tags is provided.

EPC class 1 tags using backscatter modulation will only do so when directed by a properly decoded and interpreted command. Class 1 tags will respond to all properly decoded and interpreted commands and signals regardless of the emitting source. Communication between the Reader and a Tag is packaged where a single packet includes a complete command from the Reader and a complete response from the Tag. These communications are half-duplexed. The Reader initiates communication by modulating a complete command. The Reader then transmits an unmodulated continuous wave signal. The tag modulates it. A tag will not modulate backscatter while it is waiting for a communication from a Reader. Likewise a Tag shall not interpret communication from a reader while it is communicating. EPC class 1 tags contain a unique identifier which is stored in the Identifier Tag Memory (ITM) starting at location zero. Valid class 1 electronic product codes contain four sections: version, domain manager, object class, and serial number. These sections contain information which dictate how these tags will react when provided with specific information from the reader in the form of command codes. These command codes instruct the tags to perform functions such as identifying themselves, verifying their identification, respond to commands, communicate with the reader, shut themselves off for a period of time, lock their identification sequence, erase their identification, and in some rare instances to permanently deactivate themselves. Tags can be programmed to accomplish various functions by the transmission of the appropriate code from the reader to the tag. Tags do not send commands back to the reader. These tags only execute commands issued by a reader, and send feed back to the reader. The devices use gaps in the transmission to separate these various commands.

These tags are utilized together with a label printer and an RFID Reader which is located in close physical proximity to the printer so as to print, code and verify labels from a single location. In the preferred embodiment of the invention a plurality of labels containing RFID are placed upon rolls or sheets and placed within a printer. This printer has the ability to print a label having desired series of characteristics upon the plain outer first surface. In this preferred embodiment this is a bar code type of label.

This printer is in turn connected to a control mechanism which dictates the type and form of information which can be printed upon the label. When commanded by the control device the label in the printer is printed and forwarded out of the device to another location. When this label passes out of the printer this label then passes past a sensor on the reader device.

After printing, the RFID tag needs to be verified in case of damage and optionally programmed with the related coding for inventory and tracking purposes. This process requires an RFID reader under the direction of a host controller which measures label printing, tag verification and programming.

When utilizing Class 1 and Gen 2 tags which involve the use of ASK detection, a single ended AC coupled amplifier with a DC acquisition circuit and either a comparator or firmware slicer to demodulate may be utilized. EPC Class 0 tags will require additional hardware to detect the 2.2 Mhz and 3.3 Mhz signals. Preferably, the firmware slicer is a 50 MIPS DSP microcontroller which is configured to perform filtering, edge detection and decoding. Since the printer application only addresses a single tag, a simplified singulation process can be used to identify the Tag. In the preferred embodiment of the invention the power to operate the device requires only 3.3 volts to minimize regulator requirements.

The present invention provides a method which enables a variety of label printing applications and tag coding actions to be performed. In one embodiment of the invention the reader is housed within a casing and is placed adjacent to a label printer device which is in turn connected to a control system such as a computer. The label printer contains a plurality of labels, each of these labels containing an RFID tag. The printer and the reader of the present device are operatively connected to the control computer. This computer interacts with the reader to perform the steps of the inventive method upon the printing of the label.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. In a system for printing, reading and encoding labels comprised of a printer, a sensor, a scanner and an RFID reader device all operatively connected to a data handler, and an information processing device, a method for printing, reading, and encoding labels containing an RFID tag comprising the steps of:
sensing when a label containing an RFID tag has been printed by said printer;
activating said RFID reader to attempt to read said tag;
reading said tag;
activating a label reading scanner after said RFID has successfully read said tag;
reading a code from said label with said scanner;
decoding said code from said scanner;
sending said information from said scanner to a data handler;
writing said information from said data handler to an RFID tag; and
verifying said RFID tag.

2. The method of claim 1 wherein RFID reader makes multiple attempts to read said tag.

3. The method of claim 1 further comprising the step of providing an error message if said attempts to read said RFID tag are unsuccessful.

4. The method of claim 3 further comprising the step of providing a user interface to allow a user to select a desired action when said error message is presented.

5. The method of claim 4 wherein said desired actions include trying to read the tag again.

6. The method of claim 4 wherein said desired actions include aborting the reading of said tag.

7. The method of claim 4 wherein said desired actions include manually entering information so as to activate said scanner.

8. The method of claim 1 further comprising the step of manually inputting information into said data handler before writing said information from said data handler to an RFID tag.

9. The method of claim 1 wherein said step of reading said RFID tag and said step of writing said information from said data handler to said RFID tag utilizes the sending of a signal from said RFID reader to said RFID tag utilizing a frequency hopping spread spectrum technique.

10. The method of claim 9 further comprising the step of providing an error message when said code is not successfully read.

11. The method of claim 10 further comprising the step of allowing a user to respond to said error message.

12. The method of claim 11 wherein said user may select to terminate the process of the present invention.

13. The method of claim 12 wherein said user may select to retry to read said code from said label.

14. The method of claim 13 wherein said user may select to manually enter data from said code into said data handler.

15. The method of claim 1 wherein said process terminates if said information stored within said data handler cannot be written to said RFID tag.

16. In a system for printing, reading and encoding labels comprised of a printer, a sensor, a scanner and an RFID reader device all operatively connected to a data handler, and an information processing device, a method for printing, reading, and encoding labels containing an RFID tag comprising the steps of:
sensing when a label containing an RFID tag has been printed by said printer;
activating said RFID reader to a make multiple attempt to read said tag;
providing an error message if said RFID tag cannot be read after multiple attempts to read said tag;
allowing a user to select a desired action if said multiple attempts to read said tag are unsuccessful;
activating a label reading scanner;
attempting to read a code from said label with said scanner;
providing an error message if said attempts at reading said code label are unsuccessful;
allowing user input to select a desired action if said error message is provided;
decoding said code from said scanner;
sending said information from said scanner to a data handler;
writing said information from said data handler to an RFID tag; and
verifying said RFID tag.

17. The method of claim 16 wherein said desired actions include trying to read said tag or code again, aborting the reading of said tag or code, and manually entering information so as to activate said scanner and bypass said reading steps.

18. The method of claim 17 wherein said step of reading said RFID tag and said step of writing said information from said data handler to said RFID tag utilizes the sending of a signal from said RFID reader to said RFID tag utilizing a frequency hopping spread spectrum technique.

19. The method of claim 17 wherein said process terminates if said information stored within said data handler cannot be written to said RFID tag.

20. The method of claim 16 wherein said code is a bar code.
